(19) United States
(12) Patent Application Publication
(10) Pub. No.: US 2008/0282668 A1
(43) Pub. Date: Nov. 20, 2008

(54) Ether propeller

(76) Inventor: Kristos Mavros, Lidcombe (AU)

Correspondence Address: STETINA BRUNDA GARRED & BRUCKER, 75 ENTERPRISE, SUITE 250, ALISO VIEJO, CA, 92656, US

(21) Appl. No.: 11/985,901

(22) Filed: Nov. 19, 2007

(30) Foreign Application Priority Data
May 14, 2007 (AU) 2007202160

(51) Int. Cl. F03H 5/00

(52) U.S. Cl. 60/204; 60/201

(57) ABSTRACT

A propulsion system including an electromagnetic device for reaction with a medium; said propulsion system comprising:
(e) a sectored front disc divided into an even number of charge carrying sectors,
(f) an electronic circuit including charging transistors for controlling of said charge carrying sectors,
(g) a control timer for sequencing the polarity of each charge of each of said charge carrying sectors at any given instant,
(h) an arrangement of said sequencing such that at said any given instant a positively charged sector is flanked either side by a negatively charged sector,
   and wherein, diametrically opposed sectors of said disc are of like charge at said any given instant, such that an alternating of positive and negative charging of said sectors provides a progressive rotation of diametrically opposite positively charged sectors in a first direction and a progressive rotation of diametrically opposite negatively charged sectors in a second opposite direction.

The present invention relates to propulsion systems and, in particular to propulsion systems for use in an interstellar medium.

### BACKGROUND

Space flight based on chemical propulsion systems is known to be both inefficient and hugely expensive. It is recognized that travel through interstellar space is unlikely to become a reality because of the enormous volumes of chemical fuels which would be required for even relatively modest distances within the solar system.

It is an object of the present invention to address or ameliorate some of the above disadvantages.

### Notes

The term “comprising” (and grammatical variations thereof) is used in this specification in the inclusive sense of “having” or “including”, and not in the exclusive sense of “consisting only of.”

The above discussion of the prior art in the Background of the invention, is not an admission that any information discussed therein is citable prior art or part of the common general knowledge of persons skilled in the art in any country.

### BRIEF DESCRIPTION OF INVENTION

Accordingly, in a first broad form of the invention, there is provided a propulsion system including an electromagnetic device for reaction with an interstellar medium; said propulsion system comprising:
(a) a sectored front disc divided into an even number of charge carrying sectors,
(b) an electronic circuit including charging transistors for controlling of said charge carrying sectors,
(c) a control timer for sequencing the polarity of each charge of each of said charge carrying sectors at any given instant,
(d) an arrangement of said sequencing such that at said any given instant a positively charged sector is flanked either side by a negatively charged sector,
and wherein, diametrically opposed sectors of said disc are of like charge at said any given instant, such that an alternating of positive and negative charging of said sectors provides a progressive rotation of diametrically opposite positively charged sectors in a first direction and a progressive rotation of diametrically opposite negatively charged sectors in a second opposite direction. Preferably, said disc is divided into six sectors.

Preferably, one pair of diametrically opposite sectors is sequentially controlled as a selected pair for positive charging at said any given instant.

Preferably, diametrically opposed pairs of sectors flanking said selected pair are sequentially controlled for negative charging at said given instant.

Preferably, said positive charging and said negative charging is controlled by said electronic circuit; said electronic circuit including three input signals.

Preferably, each of said three input signals controls one positive charging transistor and one negative charging transistor.

Preferably, a first said positive charging transistor is connected to a first said selected pair of diametrically opposite sectors at a first said given instant; a first said negative charging transistor connected to said diametrically opposed pairs of sectors flanking said first selected pair at said first instant.

Preferably, a second said positive charging transistor is connected to a second selected pair of diametrically opposite sectors at a second said given instant; a second said negative charging transistor connected to said diametrically opposed pairs of sectors flanking said second selected pair at said second instant.

Preferably, a third said positive charging transistor is connected to a third selected pair of diametrically opposite sectors at a third said given instant; a third said negative charging transistor connected to said diametrically opposed pairs of sectors flanking said third selected pair at said third instant.

Preferably, each of said six sectors of said disc sequentially becomes one of a selected said diametrically opposite pairs of sectors at successive said given instants.

Preferably, said system further includes a back plate; said back plate separated from said sectored front disc by a dielectric.

Preferably, said back plate is divided into sectors corresponding to said sectors of said sectored disc.

Preferably, each of said sectors of said sectored disc forms a capacitor with a respective one of said sectors of said back plate.

In a further broad form of the invention, there is provided a method of inducing a propulsive force between the electromagnetic radiation of an interstellar medium and an electromagnetic device; said method including the steps of:
(a) controlling polarity of patterns of charges on sectors of a sectored disc,
(b) providing a positive charge to a selected pair of diametrically opposite sectors of said disc at a given instant,
(c) providing a negative charge to diametrically opposite sectors of said disc flanking said selected pair at said instant,
(d) sequentially selecting successive said diametrically opposite sectors at successive instants for receiving a positive charge.

Preferably, said sectored disc is separated from a back plate by a dielectric material.

Preferably, said back plate is sectored to conform to said sectors of said sectored disc.

Preferably, a positive charge is applied to each back plate sector.

Preferably, said positive charge applied to each said back plate neutralizes negative charges of sectors of said disc such that a progressive rotation of only positively charged diametrically opposite sectors is induced.

Preferably, a power source for providing said positive and negative charges is an atomic reactor.

### BRIEF DESCRIPTION OF DRAWINGS

Embodiments of the present invention will now be described with reference to the accompanying drawings wherein:

FIG. 1 is a front view of an electro magnetic device according to a preferred embodiment of the invention,

FIG. 2 is a circuit diagram for control of charges of sectors of the electromagnetic device of FIG. 1,

FIGS. 3A to 3C are sequential diagrams showing a rotating pattern of charges applied to sectors of the electromagnetic device of FIG. 1,

FIG. 4 is a schematic of a craft utilizing the device and controlling circuit of FIGS. 1 and 2.

### DETAILED DESCRIPTION OF PREFERRED EMBODIMENTS

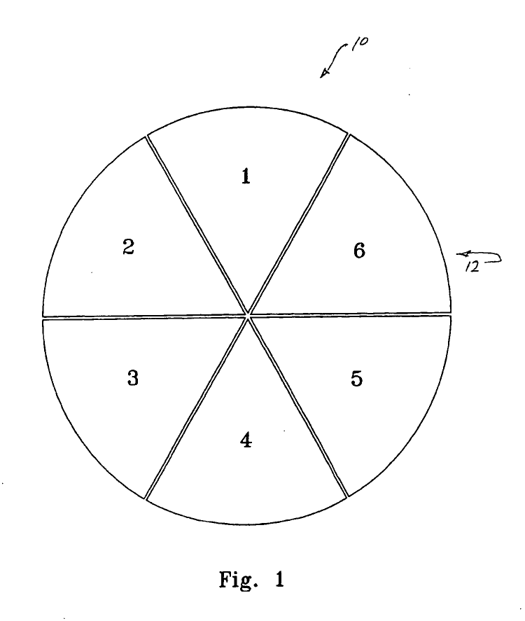

With reference to FIG. 1, a plurality of capacitors are arranged as sectors of a first or front disc 10, and a back plate 12 (not visible in FIG. 1), located one behind the other with a dielectric (which could be air) between them. Preferably, in this embodiment, the back plate or disc 12 is sectored in conformity with the front disc 10, each being divided into six sectors, numbered here for reference 1 to 6.

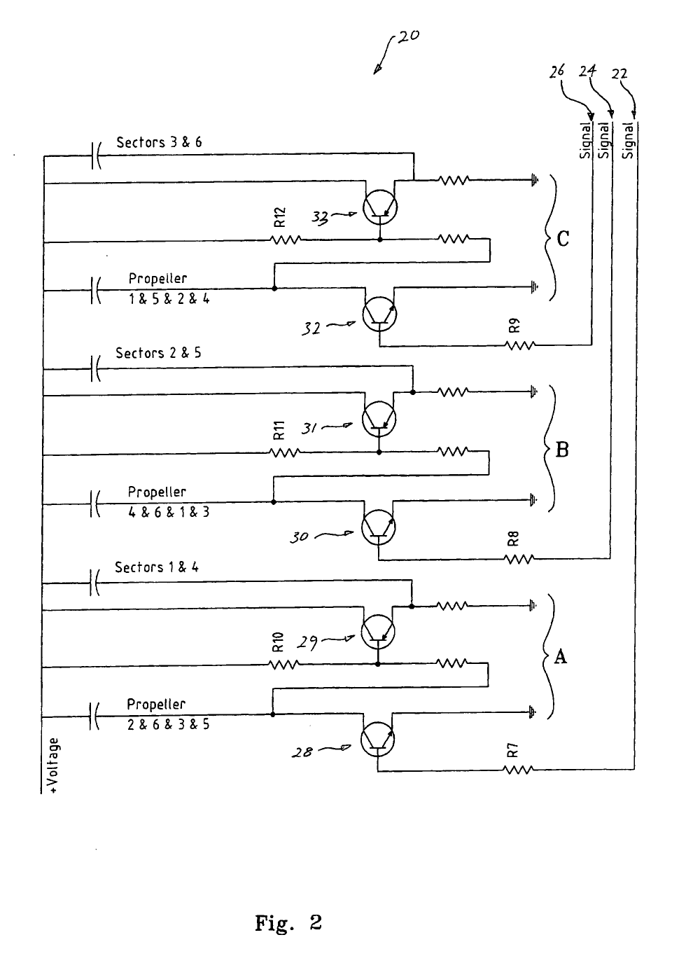

A controlling circuit 20 is provided as shown in FIG. 2 for sequentially providing patterns of negative and positive charges to the front sectors of the disc, and hence charging and discharging the capacitors 1 to 6. It can be seen that circuit 20 includes three pairs of transistor sub-circuits A, B and C, which may be supplied with input signals 22, 24 and 26. The first transistors (respectively 28, 30, and 34) in each of sub-circuits A, B and C are negative charging transistors. A timing sequencer (not shown) controls the inputs 28, 30 and 32 such that when the base of first negative charging transistor 28 goes high, both second and third negative charging transistors 30 and 32 go low.

This pattern is cyclically repeated for each of the three negative charging transistors. Thus when second negative charging transistor 30 goes high, both the first and third negative charging transistors 28 and 32 go low, and when the third negative charging transistor 32 goes high, the first and second negative charging transistors 28 and 30 go low.

It will be seen in circuit 20 that in each of the sub-circuits A, B and C, when the negative charging transistor of a sub-circuit is turned on, its associated positive charging transistor 29, 31 or 33 is turned on.

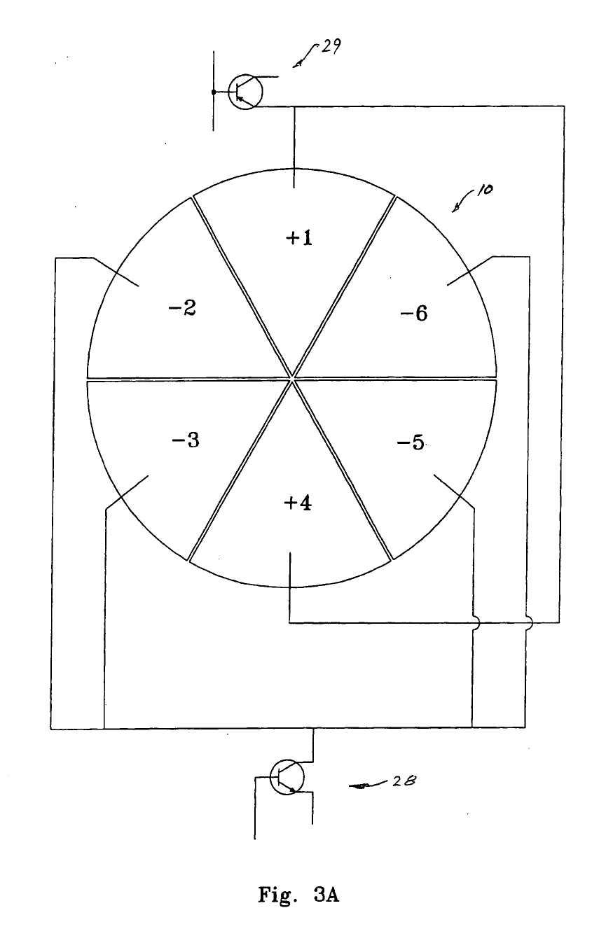

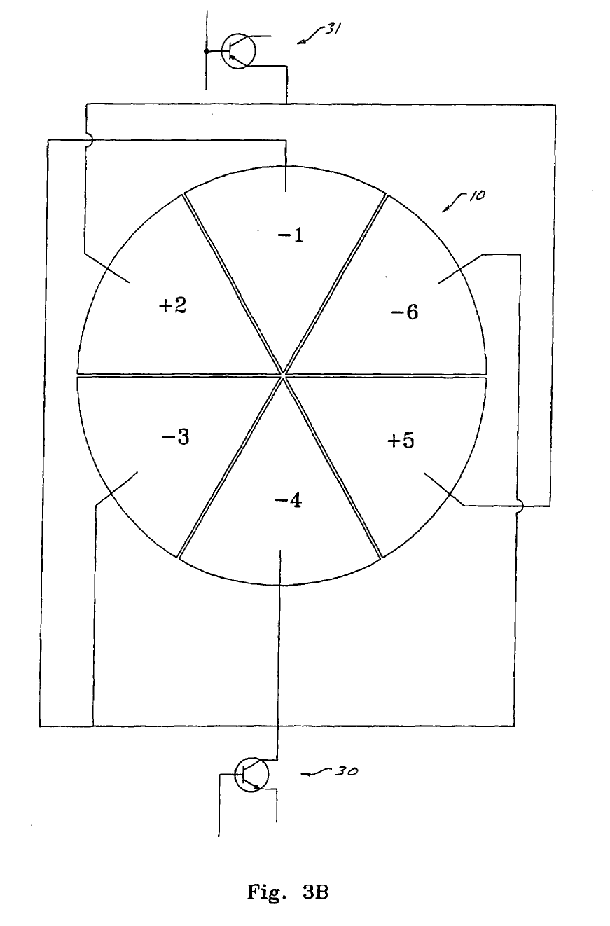

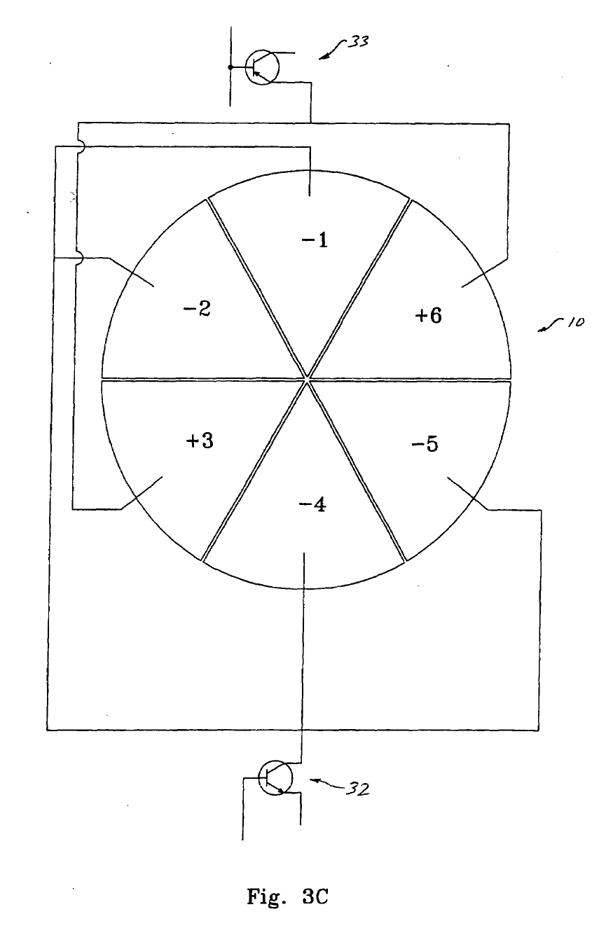

Turning now to FIGS. 3A to 3C, the negative and positive charging transistors of each sub-circuit are connected to sectors 1 to 6 of disc 10 in a particular pattern. With reference to FIG. 3A negative charging transistor 28 is connected to each of sectors 2, 6, 3 and 5, while positive charging transistor 29 is connected to sectors 1 and 4. It can be seen that when activated by input signal 22, the resulting charges on the sectors of disc 10 are such that the pair of diametrically opposite sectors 1 and 4 are positively charged, while the diametrically opposite pairs of sectors flanking sectors 1 and 4, that is sectors 2 and 6 and 3 and 5 will be negatively charged.

The sequencing controller selects at successive instances of time, successive pairs of diametrically opposite sectors for positive charging. Thus, as shown in FIG. 3B, in a next following instant (with anti-clockwise rotation), the diametrically opposite pair of sectors 2 and 5 is selected for positive charging by transistor 31 with the flanking diametrically opposite pairs 3 and 1 and 4 and 6 receiving a negative charge via transistor 30. At the next following instant shown in FIG. 3C, diametrically opposite pair of sectors 3 and 6 are selected for positive charging, with the flanking sectors 4 and 2 and 5 and 1 receiving negative charges.

The result of sequentially activating input signals 22, 24 and 26 is that there is a progressive rotation in a first direction of two diametrically opposite positively charged sectors and rotation in a second opposite direction of two pairs of diametrically opposite negatively charged sectors. Rotation direction is a function of the wiring arrangement of circuit 20.

### In Use

With the sectors 1 to 6 of disc 10 comprising capacitors, if a positive voltage is applied to the back plate sectors, there is a cancellation of the negative charged sectors of the front disc at any given instant. The effect is that there then remains only sequential rotation of two diametrically opposite positively charged sectors, in either clockwise or anti-clockwise direction, since the negative charges of the front sectors are neutralized by the positively charged back plates.

The propulsive power of the device can be calculated from the known relationship of Power being inversely proportional to the square of an applied voltage, leading to the relationship:

P=2fCV²

where P=power in watts; 2 is the number of charged positive sectors; f=frequency of the input signals 22, 24 and 26 in hertz; C=capacitance in farads and V=voltage in volts.

It follows that any increase in voltage will result in an enormous increase in power and hence the lifting thrust of the device.

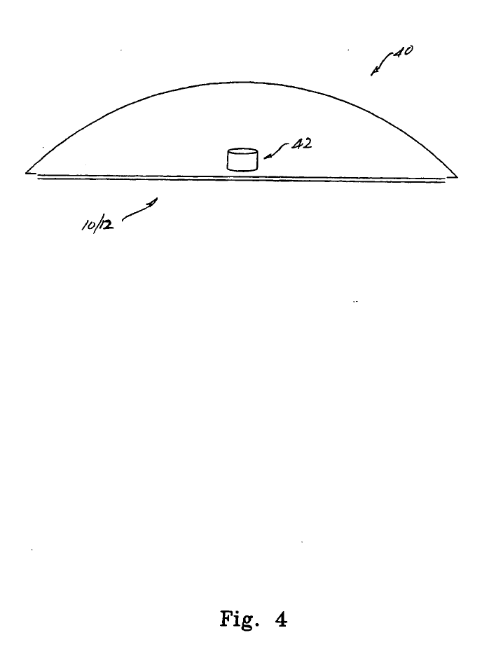

As shown in the schematic of FIG. 4, such a device as described above may be incorporated in a craft 40 capable of traversing at least interplanetary and possibly interstellar distances if supplied with a compact power source of sufficient output and duration. Such a power source could take the form of a suitable atomic reactor 42.

The above describes only some embodiments of the present invention and modifications, obvious to those skilled in the art, can be made thereto without departing from the scope of the present invention.

1. A propulsion system including an electromagnetic device for reaction with a medium; said propulsion system comprising:
(e) a sectored front disc divided into an even number of charge carrying sectors,
(f) an electronic circuit including charging transistors for controlling of said charge carrying sectors,
(g) a control timer for sequencing the polarity of each charge of each of said charge carrying sectors at any given instant,
(h) an arrangement of said sequencing such that at said any given instant a positively charged sector is flanked either side by a negatively charged sector,
and wherein, diametrically opposed sectors of said disc are of like charge at said any given instant, such that an alternating of positive and negative charging of said sectors provides a progressive rotation of diametrically opposite positively charged sectors in a first direction and a progressive rotation of diametrically opposite negatively charged sectors in a second opposite direction.

2. The system of claim 1 wherein said disc is divided into six sectors.

3. The system of claim 1 wherein one pair of diametrically opposite sectors is sequentially controlled as a selected pair for positive charging at said any given instant.

4. The system of claim 3 wherein diametrically opposed pairs of sectors flanking said selected pair are sequentially controlled for negative charging at said given instant.

5. The system of claim 4 wherein said positive charging and said negative charging is controlled by said electronic circuit; said electronic circuit including three input signals.

6. The system of claim 5 wherein each of said three input signals controls one positive charging transistor and one negative charging transistor.

7. The system of claim 6 wherein a first said positive charging transistor is connected to a first said selected pair of diametrically opposite sectors at a first said given instant; a first said negative charging transistor connected to said diametrically opposed pairs of sectors flanking said first selected pair at said first instant.

8. The system of claim 6 wherein a second said positive charging transistor is connected to a second selected pair of diametrically opposite sectors at a second said given instant; a second said negative charging transistor connected to said diametrically opposed pairs of sectors flanking said second selected pair at said second instant.

9. The system of claim 6 wherein a third said positive charging transistor is connected to a third selected pair of diametrically opposite sectors at a third said given instant; a third said negative charging transistor connected to said diametrically opposed pairs of sectors flanking said third selected pair at said third instant.

10. The system of claim 4 wherein each of said six sectors of said disc sequentially becomes one of a selected said diametrically pairs of opposite sectors at successive said given instants.

11. The system of claim 1 wherein said system further includes a back plate; said back plate separated from said sectored front disc by a dielectric.

12. The system of claim 11 wherein said back plate is divided into sectors corresponding to said sectors of said sectored disc.

13. The system of claim 12 wherein each of said sectors of said sectored disc forms a capacitor with a respective one of said sectors of said back plate.

14. A method of inducing a propulsive force between a medium and an electromagnetic device; said method including the steps of:
(a) controlling polarity of patterns of charges on sectors of a sectored disc,
(b) providing a positive charge to a selected pair of diametrically opposite sectors of said disc at a given instant,
(c) providing a negative charge to diametrically opposite sectors of said disc flanking said selected pair at said instant,
(d) sequentially selecting successive said diametrically opposite sectors at successive instants for receiving a positive charge.

15. The method of claim 14 wherein said sectored disc is separated from a back plate by a dielectric material.

16. The method of claim 15 wherein said back plate is sectored to conform to said sectors of said sectored disc.

17. The method of claim 16 wherein a positive charge is applied to each back plate sector.

18. The method of claim 17 wherein said positive charge applied to each said back plate neutralizes negative charges of sectors of said disc such that a progressive rotation of only positively charged diametrically opposite sectors is induced.

19. The method of claim 14 wherein a power source for providing said positive and negative charges is an atomic reactor.

20. The method of claim 1 wherein said medium is an interstellar medium.

21. The method of claim 20 wherein said medium is ether.
